(19) United States
(12) Patent Application Publication
(10) Pub. No.: US 2007/0065060 A1
(43) Pub. Date: Mar. 22, 2007

(54) Wheel support bearing assembly with built-in load sensor

(75) Inventors: Takashi Koike, Iwata-shi (JP); Tomomi Ishikawa, Iwata-shi (JP)

Correspondence Address: OSHA LIANG L.L.P., 1221 MCKINNEY STREET, SUITE 2800, HOUSTON, TX, 77010, US

(73) Assignee: NTN Corporation, Osaka (JP)

(21) Appl. No.: 10/563,289

(22) PCT Filed: Jun. 16, 2004
(86) PCT No.: PCT/JP04/08444

§ 371 Date: Jan. 4, 2006

(30) Foreign Application Priority Data
Jul. 4, 2003 (JP) 2003-192223

(51) Int. Cl. F16C 41/04

(52) U.S. Cl. 384/448

(57) ABSTRACT

A wheel support bearing assembly with a load sensor, in which the load sensor for detecting a load on a vehicle wheel can be compactly disposed, includes an outer member (1) having plural raceways (4) in an inner peripheral surface thereof, an inner member (2) made up of a hub axle (2A) and an inner race (2B) on an inboard end of the hub axle (2A). The inner member (2) has raceways (5) in the hub axle (2A) and the inner race (2B) confronting the raceways (4). Rows of rolling elements are interposed between the raceways (4) and (5) for supporting the vehicle wheel rotatably. A to-be-detected member (2b) as a magnetostrictive element is formed between an inboard end of the hub axle (2A) and the raceway (5). Force detecting unit for detecting a change in magnetic strain in the to-be-detected member (2b) is provided in an outer race.

### FIELD OF THE INVENTION

The present invention relates to a wheel support bearing assembly having a load sensor built therein for detecting a load imposed on a bearing unit of a vehicle wheel.

### BACKGROUND ART

The sensor-incorporated wheel support bearing assembly has hitherto been well known, which is provided with a sensor for detecting the rotational speed or number of revolutions of a vehicle wheel for the purpose of securing the running safety of an automotive vehicle. It has been suggested in, for example, the Japanese Laid-open Patent Publication No. 2002-340922 that this type of wheel support bearing assembly makes additional use of various sensors including, for example, a temperature sensor and a vibration sensor so that other parameters useful for controlling the run of the automotive vehicle than the rotational speed of the vehicle wheel can be detected together with the rotational speed.

### DISCLOSURE OF THE INVENTION

The measures for assuring the running safety of the automotive vehicle hitherto generally employed is practiced by detecting the rotational speed of each of vehicle wheels. It is, however, been found that the detection of only the rotational speed is insufficient and, therefore, it is increasingly desired that the control on the safety side can be achieved with any additional sensor signals. To meet this desire, it may be contemplated to utilize information on a load, imposed on each of the vehicle wheels during the run of the automotive vehicle, to control the attitude of the automotive vehicle. As is well known to those skilled in the art, a load does not always act on the vehicle wheels uniformly at all times during the run of the automotive vehicles. By way of example, during cornering of the automotive vehicle, a large load acts on outer vehicle wheels; during running on a leftward or rightward tilted surface, a large load acts on vehicle wheels on one side of the automotive vehicle; and during braking, a large load acts on front vehicle wheels. Also, uneven distribution of payloads leads to uneven loads acting on each vehicle wheels.

In view of the above, if loads acting on the vehicle wheels can be detected whenever necessary, the vehicle suspension system can be controlled in advance based on results of detection of those loads so that control of the attitude of the automotive vehicle such as, for example, prevention of the rolling during the cornering, prevention of the nose dive during the braking, prevention of lowering of the level of the automotive vehicle resulting from uneven distribution of payloads and so on can be accomplished. However, there is no space available for installation of load sensors for detecting respective loads acting on the vehicle wheels and, therefore, the attitude control through the detection of the loads is considered difficult to achieve.

In view of the foregoing, the present invention has been developed with a view to resolving the foregoing problems and is intended to provide a wheel support bearing assembly having a load sensor built therein for detecting the load acting on the vehicle wheel, in which the load sensor can be snugly and neatly installed on an automotive vehicle.

In order to accomplish the foregoing object, the sensor-incorporated wheel support bearing assembly for rotatably supporting a vehicle wheel relative to a vehicle body structure according to one aspect of the present invention includes an outer member having a plurality of raceway grooves defined in an inner peripheral surface thereof, an inner member positioned inside the outer member with an annular bearing space defined between it and the outer member and having a corresponding number of raceway grooves defined therein in alignment with the respective raceway grooves in the outer member, plural rows of rolling elements interposed between the raceway grooves in the outer member and the raceway grooves in the inner member, sealing members for sealing opposite open ends of the annular bearing spaces between the outer and inner members, and a load sensor disposed within the annular bearing space for detecting change in magnetic strain (magnetostriction) to thereby detect a load acting on the bearing assembly.

According to this aspect of the present invention, since the load sensor for detecting the load acting on the bearing assembly through detection of change in magnetic strain is provided within the annular bearing space delimited between the outer and inner members, no space for installation of the load sensor is required outside the bearing assembly and, therefore, the load sensor is allowed to be snugly and neatly accommodated in the automotive vehicle for the detection of the load acting on the vehicle wheel.

The inner member referred to above preferably includes a hub axle and an inner race segment mounted externally on an inboard end portion of the hub axle and the load sensor preferably includes a to-be-detected member in the form of a magnetostrictive element provided on a portion of an outer periphery of the hub axle between the inboard end portion thereof and the raceway groove and at least one force detecting unit formed in the outer member for detecting change in magnetic strain of the to-be-detected member.

According to these structural features, the magnetostrictive characteristic of the to-be-detected member varies in dependence on change of the load acting on a shaft coupled with the inner member and the force detecting unit detects such change in magnetic strain to eventually detect the load acting on the vehicle wheel. Since the to-be-detected member suffices to be formed on that portion of the outer periphery of the hub axle adjacent the inboard end portion thereof and, on the other hand, the force detecting unit suffices to be disposed inside the bearing assembly in face-to-face relation with the to-be-detected member, no space for installation of the sensor is required outside the bearing assembly, allowing the load sensor to be snugly and neatly accommodated in the automotive vehicle.

The to-be-detected member referred to above may be in the form of the magnetostrictive element made of an Fe—Al alloy and the force detecting unit may be in the form of a coil. The use of the Fe—Al alloy member is effective to increase the magnetostrictive characteristic of the to-be-detected member and, hence, the detecting precision of the load sensor can be increased. Also, the use of the coil for the force detecting unit is effective to detect the change in magnetic strain in the magnetostrictive element, which forms the to-be-detected member, with a simplified structure.

In one preferred embodiment of the present invention, the to-be-detected member may be positioned substantially intermediate between the raceway grooves. In such case, the annular bearing space available between the raceway grooves for the dual row of the rolling elements and interior spaces available in members can be effectively and efficiently utilized for accommodating the to-be-detected member and the force detecting unit.

The to-be-detected member may include a plurality of circumferentially extending axial grooves defined therein. The presence of the circumferentially extending axial grooves does advantageously allow the direction of the magnetic strain caused by the axial load to be concentrated in an axial direction to thereby increase the sensitivity.

Where a practical effect of the circumferentially extending grooves to increase the sensitivity is desired, each of the circumferentially extending grooves has a depth preferably equal to or greater than 0.1 mm.

In another preferred embodiment of the present invention, the force detecting unit may include at least two force detecting elements and further comprising a circuit for detecting a magnitude of a force and a direction, in which the force acts, in reference to a detection signal outputted from each of the force detecting elements. The force detecting unit of this embodiment also may be in the form of a coil. In a case that the force detecting unit includes at least two force detecting elements, not only the magnitude but also the direction, for example torsional direction, of the load acting on the vehicle wheel can be detected.

In the case that the force detecting unit includes at least two force detecting elements, those force detecting elements may be spaced from each other in a vertical direction and the force detecting unit may further comprise a circuit for detecting a force caused by a bending moment and an axially acting force separately in reference to the direction signal outputted from each of the force detecting elements. The use of the at least two force detecting elements spaced from each other in a vertical direction is effective to allow the following detection to be accomplished. In the event that a bending moment acts on the vehicle wheel, a tensile force or a compressive force acts on the upper force detecting element held at an upper location above the inner member and, on the other hand, a compressive force or a tensile force acts on the lower force detecting element held at a lower location below the inner member, in a manner substantially reverse to that acting on the upper force detecting element. The magnetic reluctances of the force detecting elements in the form of a detecting coil or the like positioned upwardly and downwardly of the inner member, respectively, undergoes change in dependence on the magnitude of the tensile and compressive forces, with such change being indicative of change of the load acting on the vehicle wheel. In view of this, if the difference between the respective magnetic reluctances of the upper and lower force detecting elements is calculated, the bending load acting on the hub axle and the direction thereof can be detected.

If similar force detecting members each in the form of, for example, a detecting coil are added in a horizontal direction of the inner member, the horizontally acting bending load acting on the vehicle wheel and the direction thereof can be additionally detected. When the magnetic reluctances of the force detecting members each in the form of the detecting coil are summed together, the load acting in a direction axially of the shaft can also be detected. Thus, the force brought about by the bending moment acting on the vehicle wheel and the force acting in a direction axially of the shaft can be detected with high precision.

In a further preferred embodiment of the present invention, the cylindrical mounting region of the hub axle, where the inner race segment is mounted, may be undersized in diameter relative to the raceway groove and be extended a distance towards an outboard side beyond an axial region where the inner race segment is seated, in which case a ring-shaped magnetostrictive member is press-fitted onto that portion of the cylindrical mounting region of the hub axle.

Where the magnetostrictive material which is an independent member is employed as described above, the to-be-detected member need not be formed directly in the hub axle nor the inner race segment and, therefore, machining of the hub axle and the inner race segment one at a time can advantageously be facilitated. Also, since the magnetostrictive member is mounted on that portion of the cylindrical mounting region of the hub axle which has been extended axially, not only can the magnetostrictive member be easily assembled in the bearing assembly, but also no special processing is required to mount the magnetostrictive member onto the hub axle, facilitating the assemblage of the hub axle in the bearing assembly.

According to a second aspect of the present invention, there is provided a sensor-incorporated wheel support bearing assembly for rotatably supporting a vehicle wheel relative to a vehicle body structure, which assembly includes an outer member having a plurality of raceway grooves defined in an inner peripheral surface thereof, an inner member positioned inside the outer member with an annular bearing space defined between it and the outer member and having a corresponding number of raceway grooves defined therein in alignment with the respective raceway grooves in the outer member, which inner member is made up of a hub axle and an inner race segment mounted on an inboard end portion of the hub axle, rows of rolling elements interposed between the raceway grooves in the outer member and the raceway grooves in the inner member, respectively, and a load sensor including a to-be-detected member in the form of a magnetostrictive element provided on a portion of an outer periphery of the hub axle between an outboard end portion of the inner race segment and the raceway groove and at least one force detecting unit provided in the outer member for detecting change in magnetic strain of the to-be-detected member.

According to this aspect of the present invention, where the to-be-detected member is provided in the inner race segment, the processing can be simplified since during the process of forming the to-be-detected member the inner race segment is relatively small as compared with the hub axle. It is, however, to be noted that where sealing members are employed to seal off opposite ends of both of the outer and inner members, the to-be-detected member referred to above may be disposed either within the space formed by sealing the opposite ends by the respective sealing members or outside this sealed space.

In a still further preferred embodiment of the present invention, the sensor-incorporated wheel support bearing assembly may include a transmitting means for transmitting wirelessly a force signal detected by the load sensor. The use of the wireless transmitting means is effective to dispense the use of any wiring between a control device, provided in the vehicle body structure for receiving a detected force signal, and the force detecting unit and, therefore, the wiring system can advantageously be simplified.

In a still further preferred embodiment of the present invention, the wheel support bearing assembly may additionally include one or both of a rotation sensor and a temperature sensor. In such case, not only the load acting on a shaft, but also the rotational speed and the temperature can be detected from the wheel support bearing assembly and, therefore, a sophisticated vehicle attitude control or a generation of an abnormality warning can be achieved. Since those plural detecting functions are provided in the single bearing assembly, the space required for accommodating a plurality kinds of sensors can advantageously minimized and the job of installing those sensors can also be simplified.

In the practice of the present invention, the load signal obtained from the load sensor may be utilized for an attitude control of the automotive body structure. The load signal obtained from the force detecting unit accurately reflects a change in attitude of the vehicle body structure and, therefore, utilization of this load signal is effective to allow the vehicle attitude control to be accomplished precisely.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary longitudinal sectional view of a wheel support bearing assembly having a load sensor built therein in accordance with a first preferred embodiment of the present invention, showing the structure for rotatably supporting a vehicle drive wheel;

FIG. 2 is a fragmentary longitudinal sectional view, on an enlarged scale, showing the wheel support bearing assembly with a load sensor built therein;

FIG. 3 is a fragmentary sectional view showing, on an enlarged scale, a to-be-detected member employed in the wheel support bearing assembly having the load sensor built therein;

FIG. 4A is a cross-sectional view taken along the line IV-IV in FIG. 3;

FIG. 4B is a cross-sectional view taken along the line IV-IV in FIG. 3, showing a modified form of the to-be-detected member;

FIG. 5A is a sectional view showing two coils disposed in face-to-face relation with the to-be-detected member;

FIG. 5B is a sectional view showing four coils disposed in face-to-face relation with the to-be-detected member;

FIG. 6A is a sectional view showing force detecting elements;

FIG. 6B is a fragmentary longitudinal sectional view showing one of the force detecting elements;

FIG. 7 is a block circuit diagram showing an electric processing circuit;

FIG. 8 is a block circuit diagram showing a modified form of the electric processing circuit;

FIG. 9 is a longitudinal sectional view of the wheel support bearing assembly having the load sensor built therein in accordance with a second preferred embodiment of the present invention; and

FIG. 10 is a longitudinal sectional view of the wheel support bearing assembly having the load sensor built therein in accordance with a third preferred embodiment of the present invention.

### BEST MODE FOR CARRYING OUT THE INVENTION

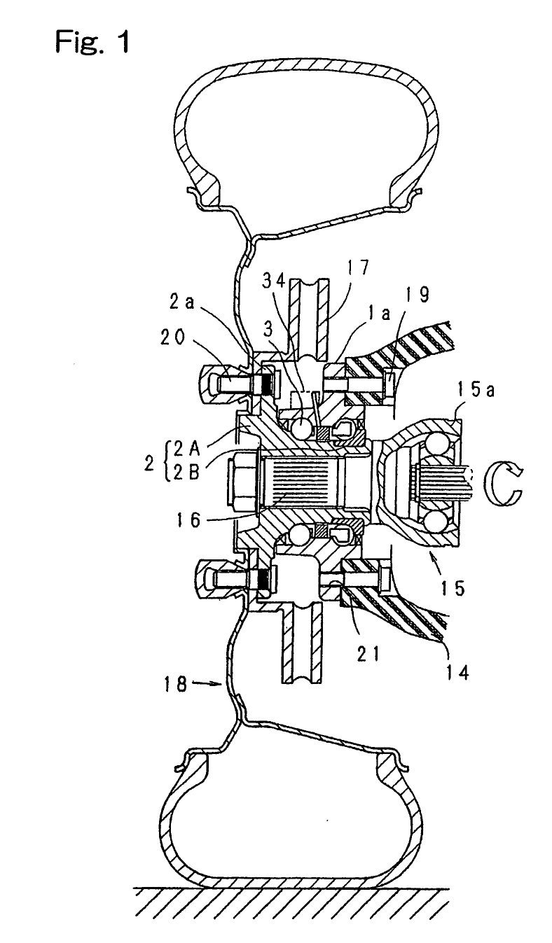

A wheel support bearing assembly having a load sensor built therein according to a first preferred embodiment of the present invention will now be described with particular reference to FIGS. 1 to 8. The wheel support bearing assembly according to this first embodiment represents a third generation model of an inner race rotating type and is so designed and so configured as to rotatably support a vehicle drive wheel.

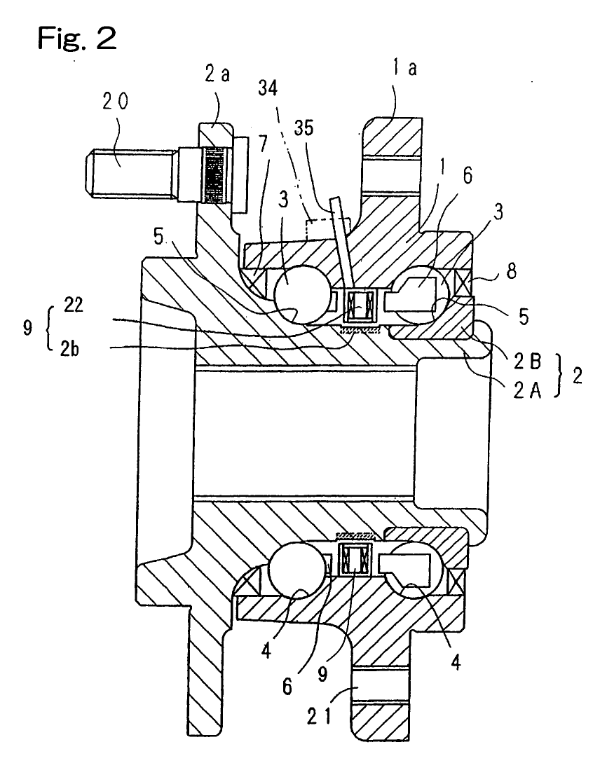

Referring first to FIG. 2, the wheel support bearing assembly shown therein includes an generally tubular outer member 1 having an inner peripheral surface formed with a plurality of, for example, two, raceway grooves 4, a generally tubular inner member 2 having an outer peripheral surface formed with raceway grooves 5 in alignment with the respective raceway grooves 4 and positioned inside the outer member 1 with an annular bearing space delimited between it and the outer member 1, and dual rows of rolling elements 3 rollingly interposed between the raceway grooves 4 in the outer member 1 and the raceway grooves 5 in the inner member 2. The illustrated wheel support bearing assembly is a dual row angular contact ball bearing, in which the raceway grooves 4 and 5 represent a generally arcuate sectional shape and are formed with their contact angles held in back-to-back relation with each other. The rolling element 3 of each row are in the form of a ball and are retained by a ball retainer 6.

The outer member 1 serves as a stationary or non-rotatable member and has a vehicle body fitting flange 1a formed integrally therewith so as to extend radially outwardly therefrom. The vehicle body fitting flange 1a is fastened to a knuckle 14, mounted rigidly on a vehicle chassis or body structure (not shown) by means of a plurality of circumferentially spaced bolts 19. Specifically, the vehicle body fitting flange 1a has internally threaded bolt insertion holes 21, into which the corresponding bolts 19 having passed through throughholes defined in the knuckle 14 are firmly threaded to thereby firmly connect the outer member 1 to the knuckle 14. It is, however, to be noted that, instead of the bolt insertion holes 21 being internally threaded, the bolt insertion holes 21 may be mere throughholes for receiving the corresponding bolts 19 so that the bolts 19 after having passed through the throughholes in the knuckle 14 and the vehicle body fitting flange 1a can be fastened with respective nuts (not shown).

The inner member 2 serves as a rotatable member and is made up of a hub axle 2A having a wheel mounting flange 2a formed integrally therewith so as to extend radially outwardly therefrom and a separate inner race segment 2B fixedly mounted on an inboard end of the hub axle 2A. The raceway grooves 5 shown and described as defined in the inner member 2 are in practice formed in an outer peripheral surface of the hub axle 2A and an outer peripheral surface of the inner race segment 2B, respectively.

As best shown in FIG. 1, the hub axle 2A has an axial bore defined therein and is coupled with a constant velocity universal joint 15, with an outer race 15a of the joint 15 inserted into the axial bore, for rotation together therewith. More specifically, the outer race 15a of the constant velocity universal joint 15 is formed integrally with a stub axle 16, which is inserted through the axial bore of the hub axle 2A and is then fastened with a nut to thereby connect the hub axle 2A firmly with the outer race 15 of the constant velocity universal joint 15. In order to secure the hub axle 2A on the stub axle 16 of the joint outer race 15a, axial grooves or splines are cut all around the stub axle 16 with matching grooves in the hub axle 2A to thereby allow the hub axle 2A and, hence, the inner member 2, and the joint outer race 15a to rotate together with each other.

The wheel mounting flange 2a is located at an outboard end of the inner member 2 and a vehicle wheel 18 is secured to the wheel mounting flange 2a by means of a plurality of bolts 20 with a brake rotor 17 intervening between the wheel mounting flange 2a and the vehicle wheel 18 as best shown in FIG. 1. The inner race segment 2B forming a part of the inner member 2 is mounted on the inboard end of the hub axle 2A and is fixedly held in position on the inboard end of the hub axle 2A by means of an inboard extremity of the hub axle 2A which has been crimped or staked radially outwardly.

The annular bearing space delimited between the outer member 1 and the inner member 2 has its opposite outboard and inboard open ends sealed by respective contact-type sealing members 7 and 8 as best shown in FIG. 2, which members 7 and 8 form respective sealing elements.

As shown in FIG. 2, the annular bearing space delimited between the outer member 1 and the inner member 2 accommodates therein a load sensor 9 that is positioned substantially intermediate between the outboard raceway grooves 4 and 5 and the inboard raceway grooves 4 and 5, i.e., between the outboard and inboard rows of the rolling elements 3. This load sensor 9 is made up of a to-be-detected member 2b and at least one force detecting unit 22 for detecting change in magnetic strain of the to-be-detected member 2b.

The to-be-detected member 2b includes a magnetostrictive element 2b formed in a cylindrical surface area of the outer peripheral surface of the inner member 2, particularly that of the hub axle 2A, bound between the raceway grooves 5 and 5 and on an inboard side of the raceway groove 5 defined in the hub axle 2A, by means of a process of imparting a magnetostrictive characteristic. While structural steel such as, for example, carbon steel is generally employed as a material for the hub axle 2A, an Fe—Al alloy is formed in at least the cylindrical surface area of the outer peripheral surface of the hub axle 2A by diffusing aluminum (Al) thereinto so that that cylindrical surface area of the outer peripheral surface of the hub axle 2A can exhibit an enhanced magnetostrictive characteristic. The to-be-detected member 2b can be readily available when that cylindrical surface area of the outer peripheral surface of the hub axle 2A is alloyed by diffusion of aluminum to form the Fe—Al alloy. However, this to-be-detected member 2b may also be available when after the entire outer peripheral surface of the hub axle 2A has been alloyed to form the Fe—Al alloy, an unnecessary portion of the entire outer peripheral surface of the hub axle 2A is ground to remove a portion of the Fe—Al alloy formed in that unnecessary portion.

As a method of diffusing aluminum into a metallic surface, the diffusion can be carried out by heating a closed vessel, containing the hub axle 2A and an aluminum powder, to a temperature of about 900° C. The depth of penetration of aluminum can be adjusted depending on the method used and the length of time during which the diffusion is effected, but is processed to be within the range of a few tens to 100 μm. The aluminum diffusion is carried out in such a manner that the concentration of aluminum in the structural steel, which forms a matrix of the hub axle 2A, may gradually decrease as the depth increases. Therefore, without the mechanical strength of the hub axle 2A being lowered, the Fe—Al alloy in the magnetostrictive diffusion layer having a high magnetostrictive characteristic can be obtained.

Specifically, when the aluminum is diffused from a surface of that cylindrical surface area of the hub axle 2A under the high temperature atmosphere so that the aluminum may be distributed from the surface thereof in a gradient concentration, it is possible to form in the steel material, which forms a matrix of the hub axle 2A, an aluminum diffusion layer in which the concentration of aluminum so diffused represents a gradient gently decreasing in a direction radially inwardly from the outer peripheral surface of the hub axle 2A. The diffusion layer having such a gradient concentration of aluminum is formed in a homogeneous alloy layer without pores such as found with an overlay spray coating and the occurrence of an early cracking, which would otherwise result from fatigue, can be suppressed considerably. Also, no cracking occurs even during the heat treatment.

If it is a magnetostrictive material prepared from a bulk material of Fe—Al alloy, it is so fragile that the processability may be lowered. However, according to the above described diffusion treatment, it has a processability similar to that exhibited by the standard steel material and the productivity can be considerably increased when the aluminum diffusion is carried out after completion of a mechanical processing of the hub axle 2A. For this reason, a low cost can be achieved.

The surface region including the raceway groove 5 and the cylindrical surface area (to-be-detected member) 2b of the hub axle 2A, which has been processed to form the Fe—Al alloy, may subjecte to a hardening treatment followed by a shot peening to increase the residue stress.

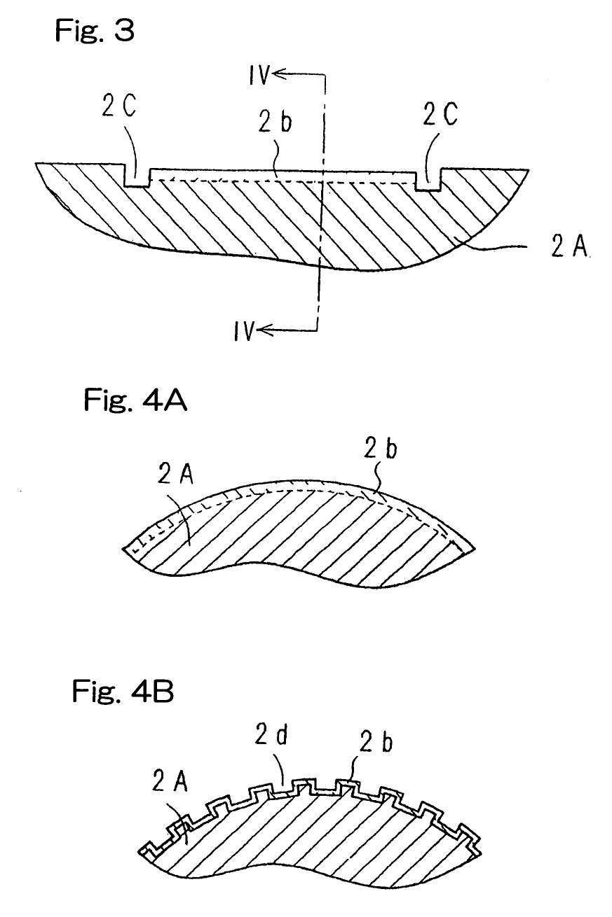

Also, the to-be-detected member 2b, which is the Al diffusion layer, may include a circumferentially extending groove 2c defined in the boundary between the Al diffusion layer and each of non-diffusion layers on respective sides of the Al diffusion layer as shown in FIG. 3. FIGS. 4A and 4B illustrate different examples of the to-be-detected member 2b in a cross-sectional representation taken along the line IV-IV in FIG. 3. Specifically, in the example shown in FIG. 4A, the to-be-detected member 2b is of a configuration, in which the aluminum is diffused on that entire cylindrical surface area of the outer peripheral surface of the hub axle 2A. Alternatively, as shown in FIG. 4B, that cylindrical surface area of the outer peripheral surface of the hub axle 2A may be, after a plurality of axially juxtaposed grooves 2d have been formed therein, be diffused with aluminum to form the to-be-detected area 2b.

Where the axially juxtaposed grooves 2d are formed in the cylindrical surface area of the outer peripheral surface of the hub axle 2A as shown in FIG. 4B, the sensitivity can be increased as the direction of electromagnetic strains generated as a result of an axial load acting therein can be concentrated in an axial direction. The axially juxtaposed grooves 2d may be formed by the use of either any known grinding process or any known knurling process and have a depth preferably within the range of 0.1 to 0.5 mm.

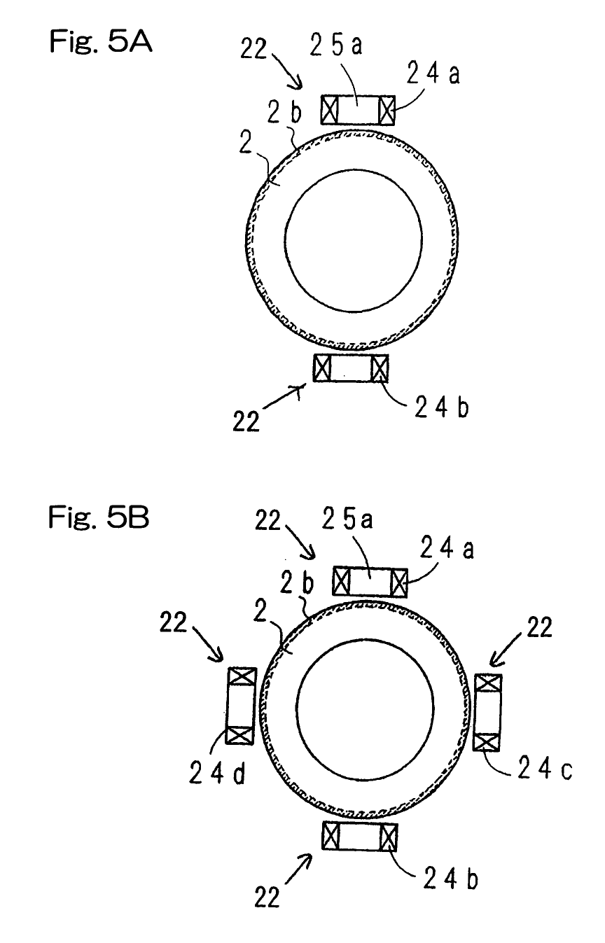

The structure of the force detecting unit 22 will now be described with particular reference to FIG. 5. In an example shown in 5A, the force detecting unit 22 includes two force detecting elements arranged radially outwardly of and in the vicinity of the inner member 2 at respective upper and lower locations lying in a vertical direction perpendicular to the longitudinal axis of the inner member 2, particularly the hub axle 2A, and spaced 180° from each other with respect to the longitudinal axis of the inner member 2. Those two force detecting elements are in the form of coiled windings 24a and 24b, which are held at the respective upper and lower locations while confronting the to-be-detected member 2b, that is in the form of the magnetostrictive element formed on that cylindrical surface area of the outer peripheral surface of the hub axle 2A, so as to detect change in magnetic strain. Thus, in the event that a vertically acting bending moment load tending to tilt the vehicle wheel 18 acts on the inner member 2, a tensile force (or a compressive force) acts on the upper to-be-detected member 2b held at the upper location and, on the other hand, a compressive force (or a tensile force) acts on the lower to-be-detected member 2b.

Respective magnetic reluctances of those coiled windings 24a and 24b undergo change in dependence on the tensile force and the compressive force acting respectively on the upper and lower to-be-detected members 2b, and the magnitude of such change is indicative of the bending moment load acting on the vehicle wheel 18. Specifically, if the difference between the respective magnetic reluctances of the upper and lower coiled windings 24a and 24b is calculated, the vertically acting bending load acting on the hub axle 2A can be detected. On the other hand, if the sum of the respective magnetic reluctances of the upper and lower coiled windings 24a and 24b is calculated, the axially acting load acting on the hub axle 2A can be detected.

In an alternative example shown in FIG. 5B, additional two force detecting elements are employed in the arrangement shown in and described with reference to FIG. 5A. Those additional two force detecting elements are similarly arranged radially outwardly of and in the vicinity of the inner member 2, but at respective right and left locations lying in a horizontal direction perpendicular to the longitudinal axis of the inner member 2 and spaced 180° from each other with respect to the longitudinal axis of the inner member 2. The right and left force detecting elements are also similarly in the form of coiled windings 24c and 24d, respectively.

With the force detecting unit 22 of the structure shown in and described with reference to FIG. 5B, not only can the vertically acting bending load be detected with the upper and lower coiled windings 24a and 24b, but the horizontally acting bending load can also be detected with the right and left coiled windings 24c and 24d. Where the force detecting unit 22, in which the four coiled windings 24a to 24d are employed at the upper, lower, right and left locations with respect to the inner member 2, the load acting axially on the hub axle 2A can be indicated by the sum of changes of the magnetic reluctances detected respectively by the four coiled windings 24a to 24d.

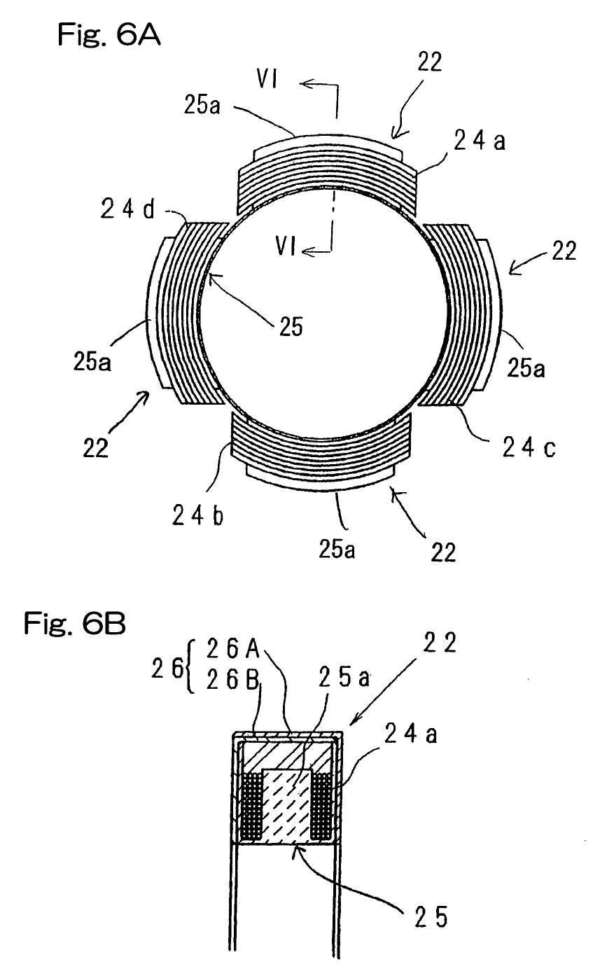

The details of the force detecting unit 22 shown in and described with reference to FIG. 5B are best shown in FIG. 6. As shown therein, the force detecting unit 22 includes a bobbin 25 made of a resin and arranged on an outer periphery of the hub axle 2A in coaxial relation with the hub axle 2A. This bobbin 25 has circumferentially equidistantly spaced radial projections 25a protruding radially outwardly therefrom, two of which lie in the vertical direction perpendicular to the longitudinal axis of the inner member 2 and the remaining two of which lie in the horizontal direction perpendicular to the longitudinal axis of the inner member 2. The windings 24a to 24d referred to previously are wound around those radial projections 25a, respectively. The bobbin 25 carrying the coiled windings 24a to 24d wound around the respective radial projections 25a is covered with a ring-shaped yoke 26 of a generally U-sectioned configuration made of a magnetic material and extending from one side to the opposite side over an outer periphery, with a molded resin subsequently filled inside the yoke 26. The yoke is 26 made up of a generally L-sectioned right yoke member 26A and a generally L-sectioned left yoke member 26B, and the bobbin 25 is substantially sandwiched between the right and left yoke members 26A and 26B so that the yoke 26 covers the bobbin 25.

The force detecting unit 22 of the structure described above is press fitted into the outer member 1 so as to be seated at a location intermediate between the raceway grooves 4 in alignment with the to-be-detected member 2b defined in the outer peripheral surface area of the hub axle 2A. At this time, the inner peripheral surface of the yoke 26 is spaced a predetermined distance from the to-be-detected member 2b on the hub axle 2A. An output from the force detecting unit 22 disposed radially inwardly of the outer member 1 is drawn to the outside of the outer member 1 by means of a connection cable 35 as shown in FIG. 2.

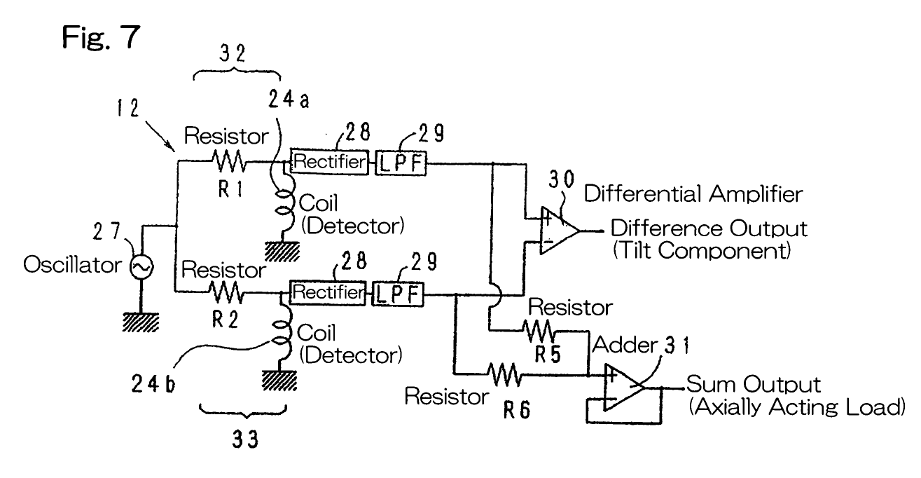

FIG. 7 illustrates an example of a processing circuit 12 for processing a detection signal outputted from the force detecting unit 22. This processing circuit 12 is applicable to and operable with the force detecting unit 22 of the structure including the upper and lower coiled windings 24a and 24b shown in FIG. 5A and is used to detect the vertically acting bending load and the axially acting load.

Referring particularly to FIG. 7, the processing circuit 12 includes a first series connected circuit 32 made up of the coiled winding 24a and a resistor R1, a second series connected circuit 33 made up of the coiled winding 24b and a resistor R2 and connected in parallel to the first series connected circuit 32, and an oscillator 27 for supplying an alternating current voltage of a few tens kHz to both of the first and second series connected circuits 32 and 33. A divided voltage across the first coiled winding 24a is converted by means of a rectifier 28 and a low pass filter 29 into a direct current voltage, which is subsequently supplied to a first input terminal of a differential amplifier 30. Also, a divided voltage across the second coiled winding 24b is converted by means of a rectifier 28 and a low pass filter 29 into a direct current voltage, which is subsequently supplied to a second input terminal of the differential amplifier 30. The differential amplifier 30 outputs a signal indicative of the difference between those two inputs from the first and second series connected circuits 32 and 33. An output from the differential amplifier 30 is an indication of a tilt component of the load, that is, the vertically acting load (the bending direction) acting on the hub axle 2A. The two inputs referred to above are supplied to and are therefore summed by an adder 31 through respective resistors R5 and R6. A sum output from the adder 31 is indicative of the magnitude of the load, that is, the load acting in an axial direction of the hub axle 2A. Thus, with the addition of the adder information, both of the magnitude of the bending load including the bending direction and the axially acting load can be detected with precision.

Those outputs may be processed in a circuit board either provided in a portion of the automotive body structure remote from the wheel support bearing assembly or fixed to the vehicle body fitting flange 1a that is rigidly connected with the knuckle 14. Where the circuit board is fixed to the vehicle body fitting flange 1a, information on the load processed in such circuit board may be transmitted wirelessly to a receiving means mounted on the vehicle body structure through a transmitting means 34 shown in FIG. 1. In such case, supply of an electric power to the circuit board may also be carried out wirelessly.

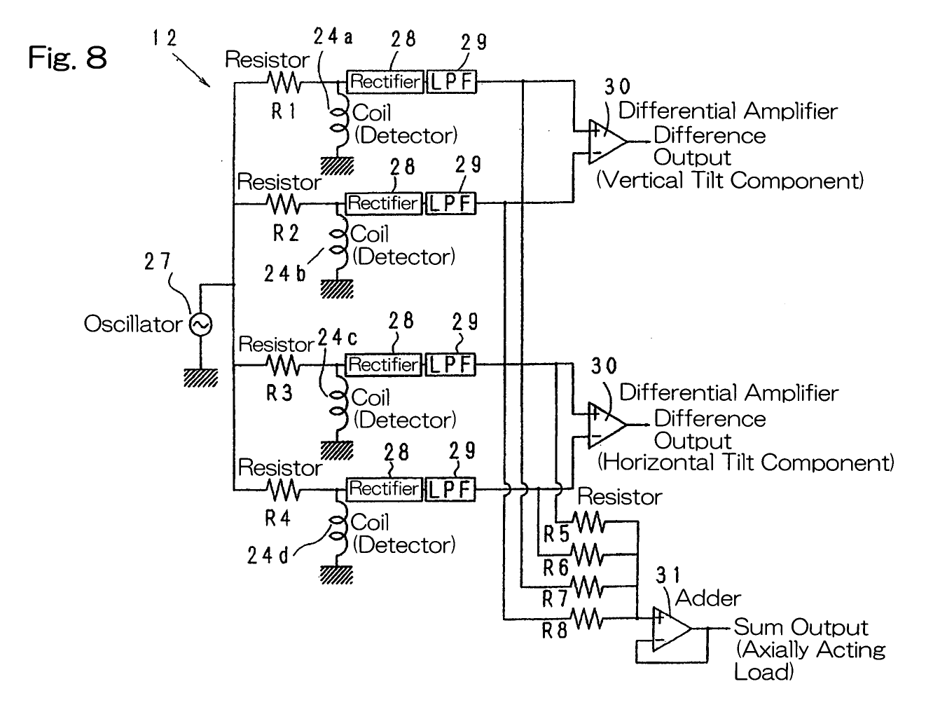

FIG. 8 illustrates a different example of the processing circuit for processing a detection signal outputted from the force detecting unit 22. This processing circuit 12A is applicable to and operable with the force detecting unit 22 of the structure including the upper, lower, right and left coiled windings 24a, 24b, 24c and 24d shown in FIG. 5B and is used to detect the vertically and horizontally acting bending loads and the axially acting load.

The detection of the horizontally acting load performed by this processing circuit 12A is substantially similar to that accomplished with the processing circuit 12 shown in and described with reference to FIG. 7. Also, if respective signals from the four coiled windings 24a to 24d, which have been passed through the corresponding low pass filters 29, are supplied to an input terminal of the adder 31 through associated resistors R5, R6, R7 and R8 to detect the axially acting load, the load acting axially of the hub axle 2A can be detected. Even in this case, with the addition of the adder information, both of the magnitude of the bending load including the bending direction and the axially acting load can be detected.

As hereinabove described, since in this wheel support bearing assembly the load sensor 9 is disposed in the space bound between the raceway grooves 4 and 5 for the dual rows of the rolling elements 3, the load sensor 9 can be snugly and neatly mounted on the automotive vehicle. Also, since the output from the load sensor 9 undergoes change when the bending load, or the load in the form of the compressive force or the tensile force acts on the hub axle 2A, the change in load acting on the vehicle wheel 18 can be detected. Accordingly, when the automobile suspension system, for example, is controlled in advance by capturing the change in output from the load sensor 9 as information, control of the attitude of the automotive vehicle such as, for example, prevention of the rolling during the cornering, prevention of the nose dive during the braking, prevention of lowering of the level of the automotive vehicle resulting from uneven distribution of payloads and so on can be accomplished.

Also, since the load sensor 9 referred to hereinbefore cooperates with the load detecting element having its electric characteristic variable in dependence on the applied load, which element is employed in the form of the Fe—Al alloyed layer having a considerable magnetostrictive effect, not only can detection of the load acting on the hub axle 2A be easily achieved with high sensitivity, but also the signal processing circuit 12 or 12A for processing the detected load signal can be simply assembled as shown in FIG. 7 or FIG. 8, respectively.

Although the Fe—Al alloy having a high magnetostrictive effect is generally fragile, formation of the Fe—Al alloy on a portion of the surface of the structural steel by the use of the aluminum diffusion technique is believed to have resulted in no substantial reduction in strength and, hence, to have resulted in a mechanical strength comparable to that exhibited by the structural steel.

Moreover, although in the foregoing embodiment, the detected load signal from the load sensor 9 has been shown and described as transmitted through the connection cable 35, the use may be made of the transmitting means 34 (shown by the phantom line in FIGS. 1 and 2) so that the detected load signal can be transmitted wirelessly. In such case, the use of the connection cable 35 or any other wiring between the load sensor 9 and a control device on the side of the automotive vehicle structure that receives the detected load signal can be advantageously dispensed with, allowing the load sensor 9 to be neatly and snugly installed.

The wheel support bearing assembly according to a second preferred embodiment of the present invention is shown in FIG. 9. This wheel support bearing assembly shown in FIG. 9 is substantially similar to that shown in and described with reference to FIGS. 1 to 8 in connection with the first embodiment of the present invention, but differs therefrom in that in place of the to-be-detected member 2b in the form of the magnetostrictive element that is formed on that specific surface area of the peripheral surface of the hub axle 2A in the previously described first embodiment, the to-be-detected member 2b is formed in a cylindrical surface area of an outer peripheral surface of the inner race segment 2B, specifically between an outboard end thereof and the raceway groove 5.

Other structural features of the wheel support bearing assembly according to the second embodiment are similar to those of the wheel support bearing assembly according to the previously described first embodiment and, therefore, the details thereof are not reiterated for the sake of brevity.

In the case of the second embodiment described above, since the inner race segment 2B is relatively small in size as compared with the hub axle 2A, the aluminum diffusion treatment to form the to-be-detected member 2b in the inner race segment 2B can be simplified advantageously.

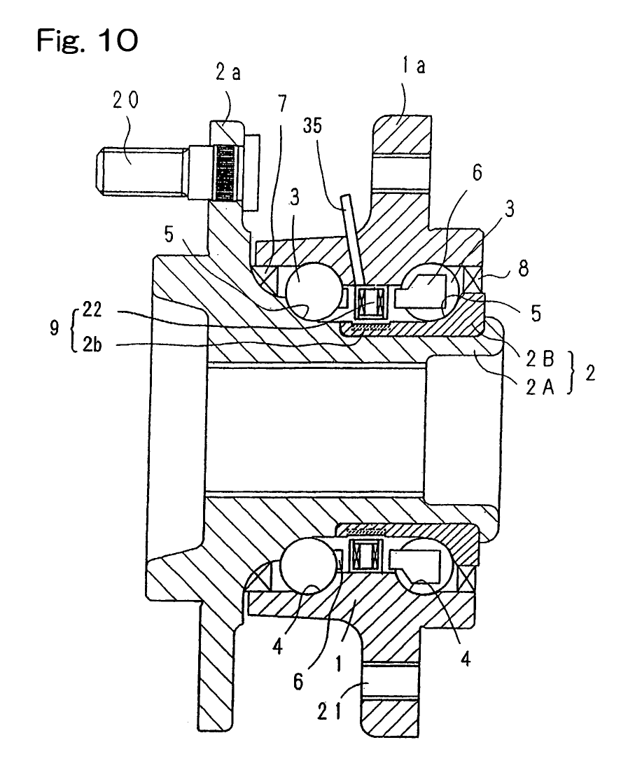

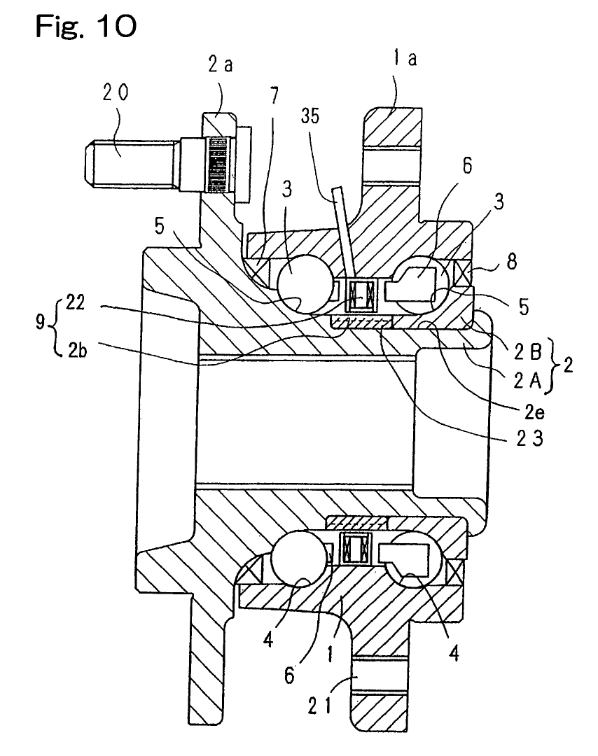

FIG. 10 illustrates the wheel support bearing assembly according to a third preferred embodiment of the present invention. This wheel support bearing assembly shown in FIG. 10 is substantially similar to that shown in and described with reference to FIGS. 1 to 8 in connection with the first embodiment of the present invention, but differs therefrom in that a cylindrical mounting region 2e of the hub axle 2A, where the inner race segment 2B is mounted, is so undersized in diameter relative to the raceway groove 5 and is extended a distance towards the outboard side beyond the axial region where the inner race segment 2B is seated and that a ring-shaped magnetostrictive member 23 is press-fitted onto that portion of the cylindrical mounting region 2e of the hub axle 2A, which has been extended towards the outboard side. The ring-shaped magnetostrictive member 23 has the to-be-detected member 2b in the form of the aluminum diffusion layer formed on a surface layer thereof. It is, however, to be noted that the magnetostrictive member 23 may be fixed on the hub axle 2B by means of a laser welding applied to the interface between it and the hub axle 2A.

In the case of the third embodiment, the to-be-detected member 2b need not be formed directly in either the hub axle 2A or the inner race segment 2B and, therefore, the processing of the hub axle 2A or the inner race segment 2B can be facilitated advantageously.

It is to be noted that in any one of the embodiments shown in and described with reference to FIGS. 9 and 10, respectively, the to-be-detected member 2b in the form of the aluminum diffusion layer may have the circumferentially extending grooves 2c such as shown in FIG. 3 and/or the axially juxtaposed grooves 2d.

Also, although not shown, in any one of the foregoing first to third embodiments, one or both of a rotation sensor and a temperature sensor may be employed in combination with the previously described load sensor 9. Yet, although in any one of the first to third embodiment, the inner member 2 has been shown and described as made up of the hub axle 2A and the inner race segment 2B, the present invention can be equally applied to the wheel support bearing assembly, in which the inner member 2 is made up of the hub axle and a plurality of inner race segments and also to the wheel support bearing assembly of a fourth generation type in which the inner member is made up of the hub axle and an outer race member of a constant velocity universal joint.

It is again to be noted that the to-be-detected member 2b may not necessarily be provided in the inner member 2 and the to-be-detected member 2b in the form of the magnetostrictive element may be provided in one of the outer and inner members 1 and 2 while the force detecting unit 22 for detecting the change in magnetic stress in the to-be-detected member 2b may be provided in the other of the outer and inner members 1 and 2. Alternatively, the both of the to-be-detected member 2b and the force detecting unit 22 may be provided in one of the outer and inner members 1 and 2. By way of example, the to-be-detected member may have a sectional shape similar to the shape of a groove-shaped ring, with the force detecting unit in the form of a coil positioned inside the to-be-detected member. In any of those cases, although one of the outer and inner members 1 and 2 may serves as a stationary member while the other of the outer and inner member 1 and 2 serves as a rotatable member, the force detecting unit is preferably provided on one of the outer and inner members 1 and 2, which serves as the stationary member, for the convenience of electric wiring.

What is claimed is:

1. A sensor-incorporated wheel support bearing assembly for rotatably supporting a vehicle wheel relative to a vehicle body structure, which assembly comprises:
an outer member having a plurality of raceway grooves defined in an inner peripheral surface thereof;
an inner member having a corresponding number of raceway grooves defined therein in alignment with the respective raceway grooves in the outer member, the inner member being positioned inside the outer member with an annular bearing space defined between it and the outer member;
plural rows of rolling elements interposed between the raceway grooves in the outer member and the raceway grooves in the inner member, respectively;
sealing members for sealing opposite open ends of the annular bearing spaces between the outer and inner members; and
a load sensor disposed within the annular bearing space for detecting change in magnetic strain to thereby detect a load acting on the bearing assembly.

2. The sensor-incorporated wheel support bearing assembly as claimed in claim 1, wherein the inner member comprises,
a hub axle and an inner race segment mounted externally on an inboard end portion of the hub axle and wherein the load sensor comprises a to-be-detected member in the form of a magnetostrictive element provided on a portion of an outer periphery of the hub axle between the inboard end portion thereof and the raceway groove, and
at least one force detecting unit provided in the outer member for detecting change in magnetic strain of the to-be-detected member.

3. The sensor-incorporated wheel support bearing assembly as claimed in claim 2, wherein the to-be-detected member is in the form of the magnetostrictive element made of an Fe—Al alloy and the force detecting unit is in the form of a coil.

4. The sensor-incorporated wheel support bearing assembly as claimed in claim 2, wherein the to-be-detected member is positioned substantially intermediate between the raceway grooves.

5. The sensor-incorporated wheel support bearing assembly as claimed in claim 2, wherein the to-be-detected member includes a plurality of circumferentially extending axial grooves defined therein.

6. The sensor-incorporated wheel support bearing assembly as claimed in claim 5, wherein each of the grooves has a depth equal to or greater than 1 mm.

7. The sensor-incorporated wheel support bearing assembly as claimed in claim 2, wherein the force detecting unit comprises at least two force detecting elements and further comprising a circuit for detecting a magnitude of a force and a direction, in which the force acts, in reference to a detection signal outputted from each of the force detecting elements.

8. The sensor-incorporated wheel support bearing assembly as claimed in claim 7, wherein the force detecting unit comprises at least two force detecting elements spaced from each other in a vertical direction and further comprising a circuit for detecting a force caused by a bending moment and an axially acting force separately in reference to the detection signal outputted from each of the force detecting elements.

9. The sensor-incorporated wheel support bearing assembly as claimed in claim 2, wherein the hub axle has a cylindrical mounting region where the inner race segment is mounted, the cylindrical mounting region being undersized in diameter relative to the raceway groove 5 and being extended a distance towards an outboard side beyond an axial region where the inner race segment is seated, and further comprising a ring-shaped magnetostrictive member press-fitted onto that portion of the cylindrical mounting region of the hub axle.

10. The sensor-incorporated wheel support bearing assembly as claimed in claim 1, further comprising a transmitting device for transmitting wirelessly a force signal detected by the load sensor.

11. The sensor-incorporated wheel support bearing assembly as claimed in claim 1, further comprising one or both of a rotation sensor and a temperature sensor.

12. The sensor-incorporated wheel support bearing assembly as claimed in claim 1, wherein a load signal obtained from the load sensor is utilized for an attitude control of the automotive body structure.

13. A sensor-incorporated wheel support bearing assembly for rotatably supporting a vehicle wheel relative to a vehicle body structure, which assembly comprises:
an outer member having a plurality of raceway grooves defined in an inner peripheral surface thereof;
an inner member having a corresponding number of raceway grooves defined therein in alignment with the respective raceway grooves in the outer member, the inner member being positioned inside the outer member with an annular bearing space defined between it and the outer member, the inner member comprising a hub axle and an inner race segment mounted on an inboard end portion of the hub axle;
plural rows of rolling elements interposed between the raceway grooves in the outer member and the raceway grooves in the inner member, respectively; and
a load sensor comprising a to-be-detected member in the form of a magnetostrictive element provided on a portion of an outer periphery of the hub axle between an inboard end portion of the inner race segment and the raceway groove and at least one force detecting unit provided in the outer member for detecting change in magnetic strain of the to-be-detected member.

14. The sensor-incorporated wheel support bearing assembly as claimed in claim 13, further comprising a transmitting devices for transmitting wirelessly a force signal detected by the load sensor.

15. The sensor-incorporated wheel support bearing assembly as claimed in claim 13, further comprising one or both of a rotation sensor and a temperature sensor.

16. The sensor-incorporated wheel support bearing assembly as claimed in claim 13, wherein a load signal obtained from the load sensor is utilized for an attitude control of the automotive body structure.
